(19) United States
(12) Patent Application Publication
(10) Pub. No.: US 2024/0361193 A1
(43) Pub. Date: Oct. 31, 2024

(54) LOAD SENSOR

(71) Applicant: Panasonic Intellectual Property Management Co., Ltd., Osaka (JP)

(72) Inventors: Yui AIHARA, Chiba (JP); Yuta MORIURA, Osaka (JP); Susumu URAGAMI, Kumamoto (JP)

(21) Appl. No.: 18/768,251

(22) Filed: Jul. 10, 2024

Related U.S. Application Data
(63) Continuation of application No. PCT/JP2022/046716, filed on Dec. 19, 2022.

(30) Foreign Application Priority Data
Jan. 12, 2022 (JP) 2022-003407

(51) Int. Cl. G01L 1/14

(52) U.S. Cl. CPC G01L 1/14

(57) ABSTRACT

A load sensor includes: an electrode; a dielectric body disposed on a surface of the electrode; an electrically-conductive elastic body that is disposed so as to be opposed to the dielectric body and of which a surface on the dielectric body side has a projection formed thereon; a substrate configured to support the electrically-conductive elastic body; and a configuration (projection) that suppresses movement of the electrically-conductive elastic body in a horizontal direction.

### CROSS REFERENCE TO RELATED APPLICATION

This application is a continuation of International Application No. PCT/JP2022/046716 filed on Dec. 19, 2022, entitled “LOAD SENSOR”, which claims priority under 35 U.S.C. Section 119 of Japanese Patent Application No. 2022-003407 filed on Jan. 12, 2022, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

To date, as a human machine interface (HMI), capacitance-type load sensors have been used for various devices such as keyboards and game controllers. For example, Japanese Patent No. 4429478 describes a force detector that includes a main substrate, an electrode, an insulating layer, a displacement generator, and an elastic electrically-conductive layer. In this device, the electrode is formed on the upper face of the main substrate and is covered with the insulating layer. The displacement generator includes a fixed part, a flexible part, and an action part, and the action part is connected, via the flexible part, to the fixed part fixed to the main substrate. The elastic electrically-conductive layer is formed on the bottom face of the action part, and a rough surface composed of a large number of uneven structures is formed on the lower face of the elastic electrically-conductive layer. When the action part is pressed against the main substrate, the contact state between the upper face of the insulating layer and the rough surface of the elastic electrically-conductive layer changes, so that the capacitance based on the electrode and the elastic electrically-conductive layer changes. The magnitude of the capacitance is electrically detected, whereby the applied force (load) is detected.

In a capacitance-type load sensor, it is preferable that the detection range (dynamic range) of the load is as wide as possible. In Japanese Patent No. 4429478 above, the dynamic range can be widened if the elastic electrically-conductive layer is formed from a hard material, but the selection of the material is limited.

### SUMMARY OF THE INVENTION

A load sensor according to a main aspect of the present invention includes: an electrode; a dielectric body disposed on a surface of the electrode; an electrically-conductive elastic body that is disposed so as to be opposed to the dielectric body and of which a surface on the dielectric body side has a projection formed thereon; a substrate configured to support the electrically-conductive elastic body; and a configuration that suppresses movement of the electrically-conductive elastic body in a horizontal direction.

In the load sensor according to the present aspect, the projection of the electrically-conductive elastic body is compressed in the thickness direction due to load application. At this time, as for the electrically-conductive elastic body, movement in the horizontal direction is suppressed, and thus, the projection is less likely to be elastically deformed. Accordingly, the projection of the electrically-conductive elastic body can be continued to be elastically deformed up to a high load range, and as a result, the range of the detectable load can be widened. Therefore, the dynamic range of load detection can be widened by a simple configuration of suppressing movement of the electrically-conductive elastic body in the horizontal direction.

The effects and the significance of the present invention will be further clarified by the description of the embodiments below. However, the embodiments below are merely some examples for implementing the present invention. The present invention is not limited to the description of the embodiments below in any way.

### BRIEF DESCRIPTION OF THE DRAWINGS

FIG. 1 is an exploded perspective view schematically showing a configuration of a load sensor according to Embodiment 1;

FIG. 2A is a perspective view schematically showing a structure of the load sensor according to Embodiment 1;

FIG. 2B is a side view schematically showing a state of the load sensor in an initial state (a state where no load is applied) according to Embodiment 1;

FIG. 3A and FIG. 3B are each a side view schematically showing a state of the load sensor during load application according to Embodiment 1;

FIG. 4A to FIG. 4C are each a diagram for describing a simulation condition of Verification 1 according to Embodiment 1;

FIG. 5A and FIG. 5B are each a graph showing a simulation result of Verification 1 according to Embodiment 1;

FIG. 6A and FIG. 6B are each a graph showing a simulation result of Verification 2 according to Embodiment 1;

FIG. 7 is an exploded perspective view schematically showing a configuration of the load sensor according to Embodiment 2;

FIG. 8A is a perspective view schematically showing a structure of the load sensor according to Embodiment 2;

FIG. 8B is a diagram for describing a simulation condition of Verification 3 according to Embodiment 2;

FIG. 9A and FIG. 9B are each a graph showing a simulation result of Verification 3 according to Embodiment 2;

FIG. 10A and FIG. 10B are each a graph showing a simulation result of Verification 4 according to Embodiment 2;

FIG. 11A is a perspective view schematically showing a configuration of the load sensor according to Embodiment 3;

FIG. 11B is a diagram for describing a simulation condition of Verification 5 according to Embodiment 3;

FIG. 12A and FIG. 12B are each a graph showing a simulation result of Verification 5 according to Embodiment 3;

FIG. 13A and FIG. 13B are each a graph showing a simulation result of Verification 6 according to Embodiment 3;

FIG. 14A and FIG. 14B are each an exploded perspective view showing configurations of a substrate and an electrically-conductive elastic body according to a modification of Embodiment 1;

FIG. 15A and FIG. 15B are each an exploded perspective view showing configurations of the substrate and the electrically-conductive elastic body according to another modification of Embodiment 1;

FIG. 16A and FIG. 16B are each an exploded perspective view showing configurations of the substrate and the electrically-conductive elastic body according to another modification of Embodiment 1;

FIG. 17A is an exploded perspective view showing configurations of the substrate and the electrically-conductive elastic body according to another modification of Embodiment 1;

FIG. 17B is a plan view of the substrate according to another modification of Embodiment 1;

FIG. 18A and FIG. 18B are each an exploded perspective view showing configurations of the substrate and the electrically-conductive elastic body according to another modification of Embodiment 1; and

FIG. 19A and FIG. 19B are each an exploded perspective view showing configurations of the substrate and the electrically-conductive elastic body according to a modification of Embodiment 2.

It is noted that the drawings are solely for description and do not limit the scope of the present invention in any way.

### DETAILED DESCRIPTION

The present invention is applicable to an input part for performing an input according to an applied load. Specifically, the present invention is applicable to: an input part of an electronic apparatus such as a PC keyboard; an input part of a game controller; a surface layer part for a robot hand to detect an object; an input part for inputting a sound volume, an air volume, a light amount, a temperature, and the like; an input part of a wearable device such as a smartwatch; an input part of a hearable device such as a wireless earphone; an input part of a touch panel; an input part for adjusting an ink amount and the like in an electronic pen; an input part for adjusting a light amount, a color, and the like in a penlight; an input part for adjusting a light amount and the like in lighting clothes; an input part for adjusting a sound volume and the like in a musical instrument; etc.

The embodiments below are load sensors that are typically provided in the above devices. Such a load sensor is referred to as a “capacitance-type pressure-sensitive sensor element”, a “capacitive pressure detection sensor element”, a “pressure-sensitive switch element”, or the like. The embodiments below are some examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 10.

### Embodiment 1

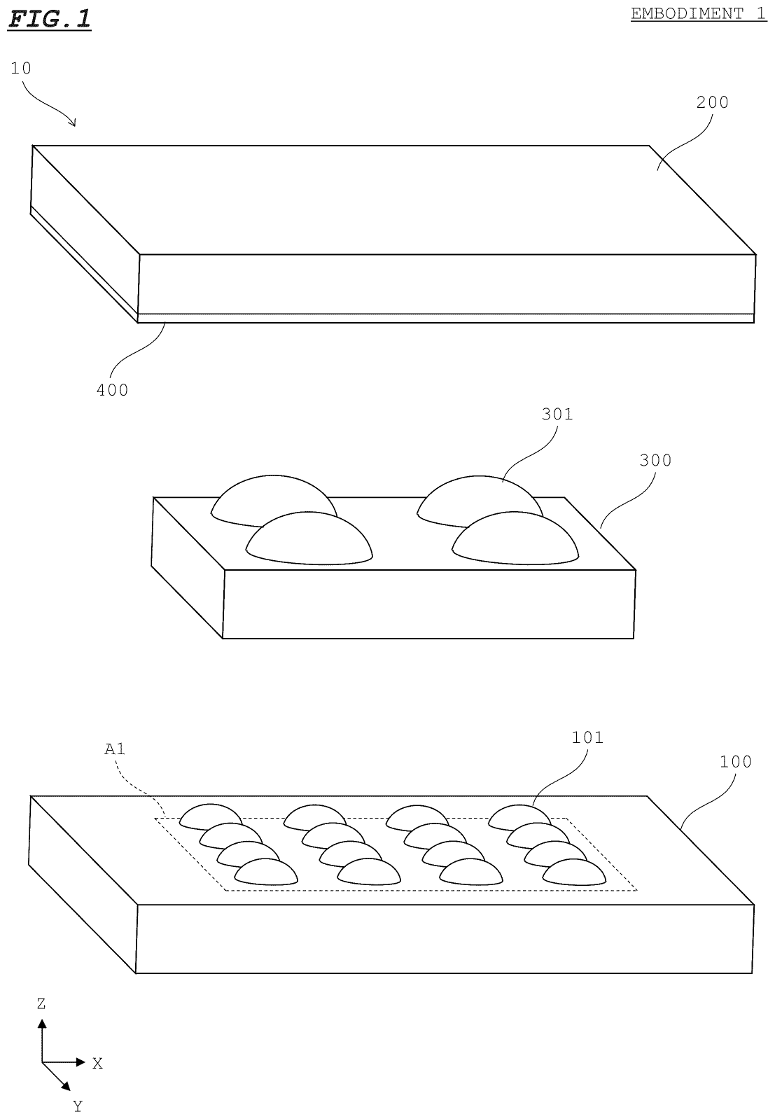

FIG. 1 is an exploded perspective view schematically showing a configuration of the load sensor 10.

The load sensor 10 includes a substrate 100, an electrode 200, an electrically-conductive elastic body 300, and a dielectric body 400.

The substrate 100 is a rectangular parallelepiped-shaped member having a predetermined thickness. The substrate 100 is a support member for supporting the electrically-conductive elastic body 300. The substrate 100 is formed from an electrically-conductive metal material having a high rigidity, and forms one electrode of the load sensor 10. That is, the substrate 100 is an electrode plate. The substrate 100 is formed from SUS, for example. The substrate 100 may be formed from another material. As long as the rigidity can be ensured, the substrate 100 may be formed from the same material as that of the electrode 200. The substrate 100 has a substantially square shape in a plan view. The lower face and the upper face of the substrate 100 is parallel to an X-Y plane.

At the center of the upper face of the substrate 100, a plurality of projections 101 each having a spherical surface shape are formed. Here, 16 projections 101 in four rows and four columns are formed on the upper face of the substrate 100 so as to be arranged in a grid pattern. In Embodiment 1, the pitch of the projections 101 in the Y-axis direction is constant, and the pitch of the projections 101 in the X-axis direction is also constant. The shapes and the sizes of the projections 101 are the same with each other.

These projections 101 are formed in a joint region A1, in the upper face of the substrate 100, to which the electrically-conductive elastic body 300 is joined. The projections 101 are formed integrally with the substrate 100 by press working, for example. The projections 101 may be formed integrally with the upper face of the substrate 100 by outsert molding or the like. In this case, the projections 101 may be formed from a material, such as a resin, different from that of the substrate 100.

The electrode 200 is formed from a metal material having electrical conductivity. The material of the electrode 200 is selected from In₂O₃, ZnO and/or SnO₂, or the like, for example. Similar to the substrate 100, the material of the electrode 200 may be SUS. The electrode 200 is a substantially square plate-shaped member in a plan view. In a plan view, the size of the electrode 200 is substantially identical to the size of the substrate 100. The substrate 100 and the electrode 200 are connected to a detection circuit for detecting a load.

The electrically-conductive elastic body 300 is an elastic member having electrical conductivity, and has a substantially square shape in a plan view. The electrically-conductive elastic body 300 is formed from a resin material and an electrically-conductive filler dispersed therein, or from a rubber material and an electrically-conductive filler dispersed therein. In a case where a resin material is used for the electrically-conductive elastic body 300, the resin material is, for example, a styrene-based resin, a silicone-based resin (e.g., polydimethylpolysiloxane (PDMS)), an acrylic resin, a rotaxane-based resin, a urethane-based resin, or the like.

In a case were a rubber material is used for the electrically-conductive elastic body 300, the rubber material is, for example, a rubber material of at least one type selected from silicone rubber, isoprene rubber, butadiene rubber, styrene-butadiene rubber, chloroprene rubber, nitrile rubber, polyisobutylene, ethylene propylene rubber, chlorosulfonated polyethylene, acrylic rubber, fluororubber, epichlorohydrin rubber, and urethane rubber. The electrically-conductive filler used for the electrically-conductive elastic body 300 is, for example, a material of at least one type selected from Au (gold), Ag (silver), Cu (copper), C (carbon), ZnO (zinc oxide), In₂O₃ (indium (III) oxide), and SnO₂ (tin (IV) oxide).

On the upper face of the electrically-conductive elastic body 300, a plurality of projections 301 projecting upward are formed so as to be arranged in a grid pattern. Here, four projections 301 in two rows and two columns are formed on the upper face of the electrically-conductive elastic body 300. In Embodiment 1, the pitch of the projections 301 in the Y-axis direction is constant, and the pitch of the projections 301 in the X-axis direction is also constant. The thickness of the electrically-conductive elastic body 300 is constant except for the portions of the projections 301.

The cross-sectional area of each projection 301 becomes smaller toward the Z-axis negative direction. Here, the projection 301 has a spherical surface shape. The shapes and the sizes of the projections 301 are the same with each other. The electrically-conductive elastic body 300 is connected, via the substrate 100, to the detection circuit for detecting a load.

The dielectric body 400 is formed on the lower face of the electrode 200. The dielectric body 400 is formed from a material having an electric insulation property. The material for the dielectric body 400 is selected from, for example, a polypropylene resin, a polyethylene terephthalate resin, a polyimide resin, a polyphenylene sulfide resin, Al₂O₃, Ta₂O₅, and the like. The dielectric body 400 is formed on the lower face of the electrode 200 by insert molding, for example. The thickness of the dielectric body 400 is constant.

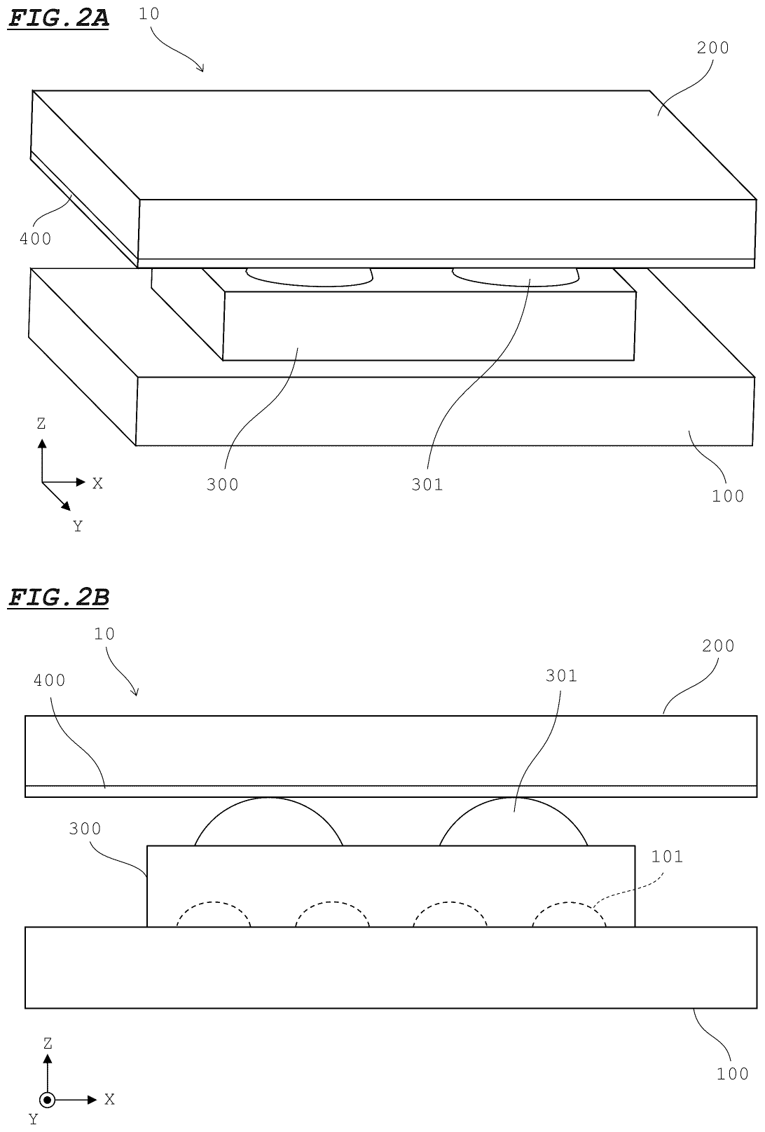

During assembly of the load sensor 10, the electrically-conductive elastic body 300 is formed integrally with the upper face of the substrate 100 by outsert molding or the like. At the same time, a plurality of projections 301 are formed on the upper face of the electrically-conductive elastic body 300. Further, a structure composed of the dielectric body 400 and the electrode 200 is superposed on the upper face of the electrically-conductive elastic body 300 such that the dielectric body 400 is opposed to the electrically-conductive elastic body 300. Accordingly, the structure shown in FIG. 2A is formed. Protection substrates (not shown) formed from a resin material are superposed on the upper face and the lower face of this structure, respectively, and the peripheries of these protection substrates are joined by a setting member. Then, the load sensor 10 is completed.

FIG. 2B is a side view schematically showing a state of the load sensor 10 in an initial state (a state where no load is applied).

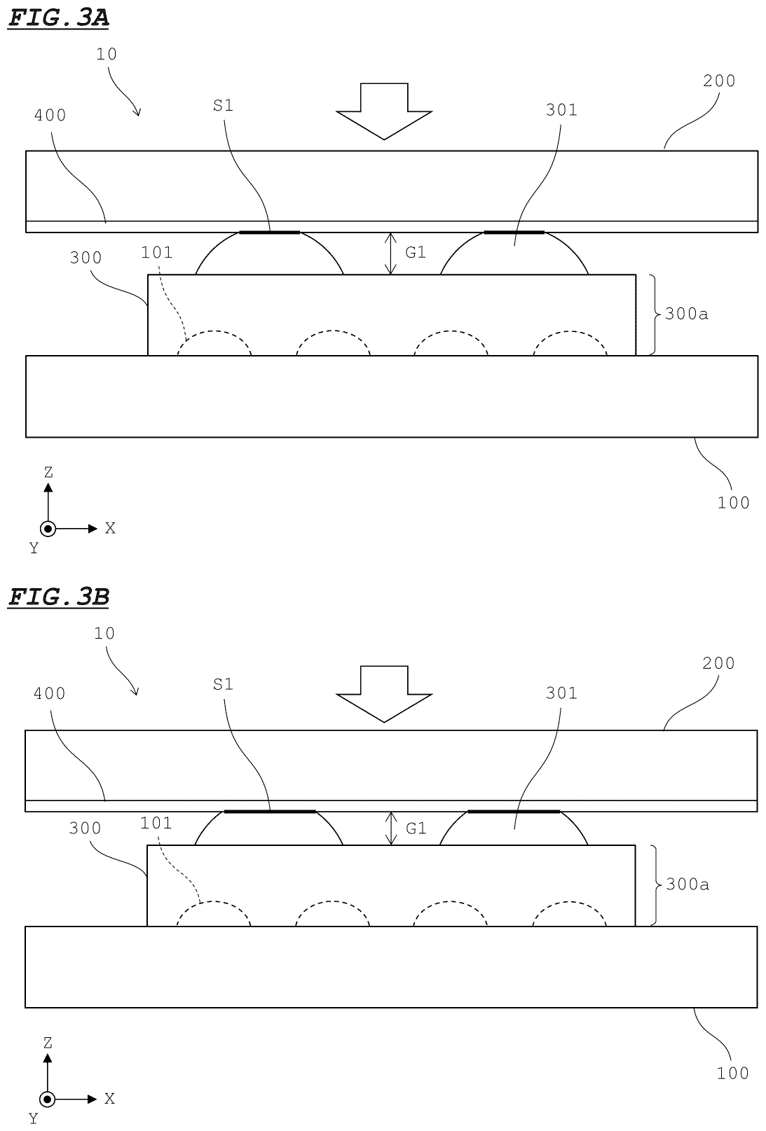

As shown in FIG. 2B, in the initial state where no load is applied, a top portion of each projection 301 is in a state of being in contact with the lower face of the dielectric body 400. From this state, when a load is applied to the upper face of the electrode 200, as shown in FIG. 3A, the projection 301 is compressed downward, a contact area S1 between the projection 301 and the dielectric body 400 increases, and a gap G1 between the lower face of the dielectric body 400 and the upper face of the electrically-conductive elastic body 300 becomes small. From this state, when the load is further increased, the contact area S1 further increases and the gap G1 becomes further smaller as shown in FIG. 3B.

Here, the capacitance between the electrode 200 and the electrically-conductive elastic body 300 is proportional to the contact area S1, and is inversely proportional to the gap G1. Therefore, the capacitance between the electrode 200 and the electrically-conductive elastic body 300 increases in association with increase in the load. When the magnitude of this capacitance is detected by the detection circuit, the load applied to the load sensor 10 is detected.

Meanwhile, in the load sensor 10 of a capacitance type as in this case, it is preferable that the detection range (dynamic range) of the load is as wide as possible. In Embodiment 1, as described above, the plurality of projections 101 are formed in the joint region A1 of the upper face of the substrate 100 to which the electrically-conductive elastic body 300 is joined, whereby expansion of the dynamic range is realized.

That is, in a case where these projections 101 are not formed, when the projections 301 are compressed as in FIGS. 3A, 3B, a part of the volume of the projections 301 moves to a thickness portion 300a of the electrically-conductive elastic body 300 other than the projections 301, and in association with this, the thickness portion 300a of the electrically-conductive elastic body 300 spreads in the horizontal direction (the direction parallel to an X-Y plane).

In contrast, in Embodiment 1, since the plurality of projections 101 formed on the upper face of the substrate 100 have entered the thickness portion 300a of the electrically-conductive elastic body 300, spreading of the thickness portion 300a of the electrically-conductive elastic body 300 in the horizontal direction is suppressed. Therefore, spreading in the horizontal direction of the electrically-conductive elastic body 300 during load application as described above is suppressed. Accordingly, movement of a part of the volume of the projections 301 to the thickness portion 300a of the electrically-conductive elastic body 300 during load application is also suppressed, and the projections 301 are less likely to be elastically deformed in the up-down direction. Therefore, changes in the contact area S1 and the gap G1 during load application become gentle, and as a result, the dynamic range of load detection can be expanded as compared with a case where there is no projection 101.

### <Verification 1>

The inventors verified, through simulation, effects according to the configuration of Embodiment 1 above, i.e., effects of providing the projections 101 on the upper face of the substrate 100.

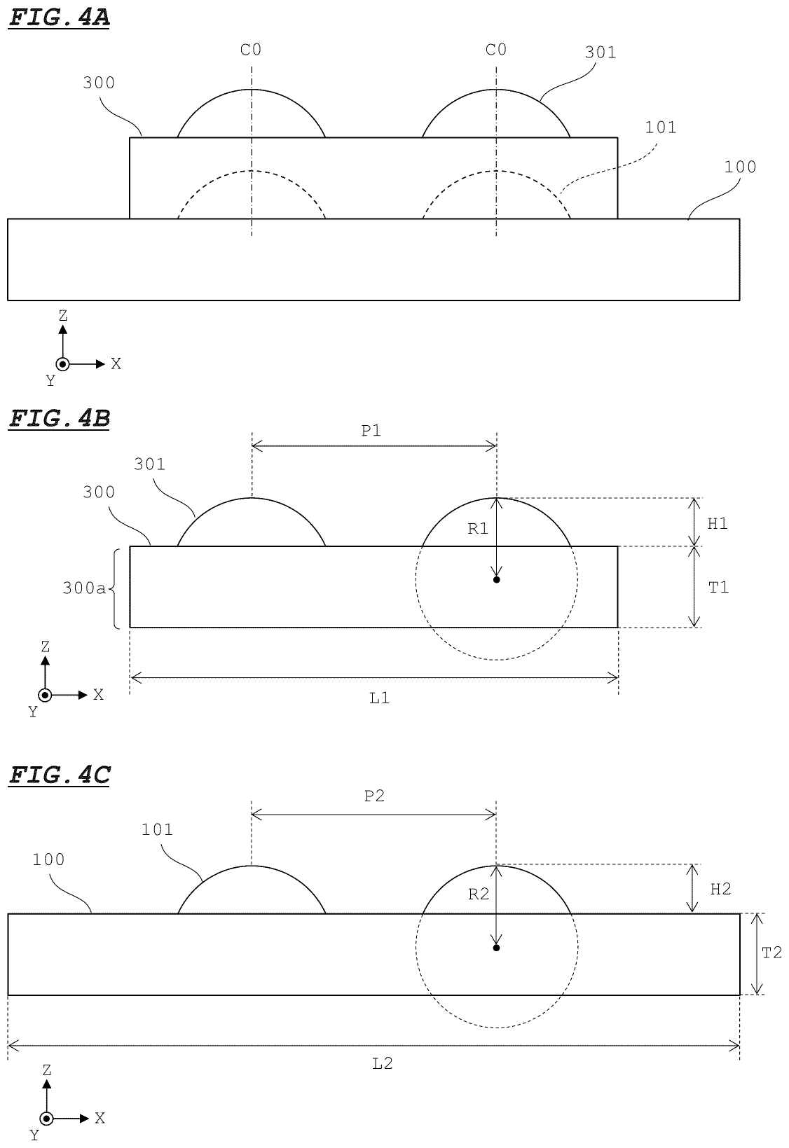

FIGS. 4A to 4C are each a diagram for describing a simulation condition of the present verification.

In the present verification, as shown in FIG. 1, it is assumed that four projections 301 are formed on the upper face of the electrically-conductive elastic body 300. In addition, as shown in FIG. 4A, it is assumed that four projections 101 are formed on the upper face of the substrate 100 at positions immediately below these four projections 301, respectively. That is, each projection 301 and a corresponding projection 101 immediately therebelow have the same central axis CO. A pitch P1 of the four projections 301 formed on the upper face of the electrically-conductive elastic body 300 is constant in the X-axis direction and the Y-axis direction. A pitch P2 of the four projections 101 formed on the upper face of the substrate 100 is constant in the X-axis direction and the Y-axis direction.

With reference to FIG. 4B, the pitch P1 between the projections 301 of the electrically-conductive elastic body 300 was set to 0.3 mm. A radius R1 of each projection 301 was set to 0.1 mm, and a height H1 of the projection 301 was set to 0.06 mm. A thickness T1 of the portion (the thickness portion 300a), other than the projections 301, of the electrically-conductive elastic body 300 was set to 0.1 mm. The electrically-conductive elastic body 300 in a plan view was square as described above, and a length L1 of one side of this square was set to 0.6 mm.

With reference to FIG. 4C, the pitch P2 between the projections 101 of the substrate 100 was set to 0.3 mm. A radius R2 of each projection 101 was set to 0.1 mm, and a height H2 of the projection 101 was set to 0.06 mm. A thickness T2 of the portion, other than the projections 101, of the substrate 100 was set to 0.1 mm. The substrate 100 in a plan view was square as described above, and a length L2 of one side of this square was set to 0.9 mm.

Under this condition, a structure composed of the electrode 200 and the dielectric body 400 was superposed on the configuration in FIG. 4A, as in FIG. 2B, to form the load sensor 10. Then, the relationship, when a load was applied to the upper face of the electrode 200, between the load and the displacement amount in the Z-axis negative direction of the vertex of the projection 301 in FIG. 4B was obtained through simulation. Further, the relationship, when a load was applied to the upper face of the electrode 200, between the load and the capacitance between the electrode 200 and the substrate 100 was obtained through simulation.

Further, as a comparative example, with respect to a configuration in which no projection 101 is formed on the upper face of the substrate 100, the relationship between the load and the displacement amount in the Z-axis negative direction of the vertex of the projection 301 in FIG. 4B and the relationship between the load and the capacitance between the electrode 200 and the substrate 100 were obtained through simulation. The simulation condition in the comparative example was set to be the same as above except that the projections 101 are omitted.

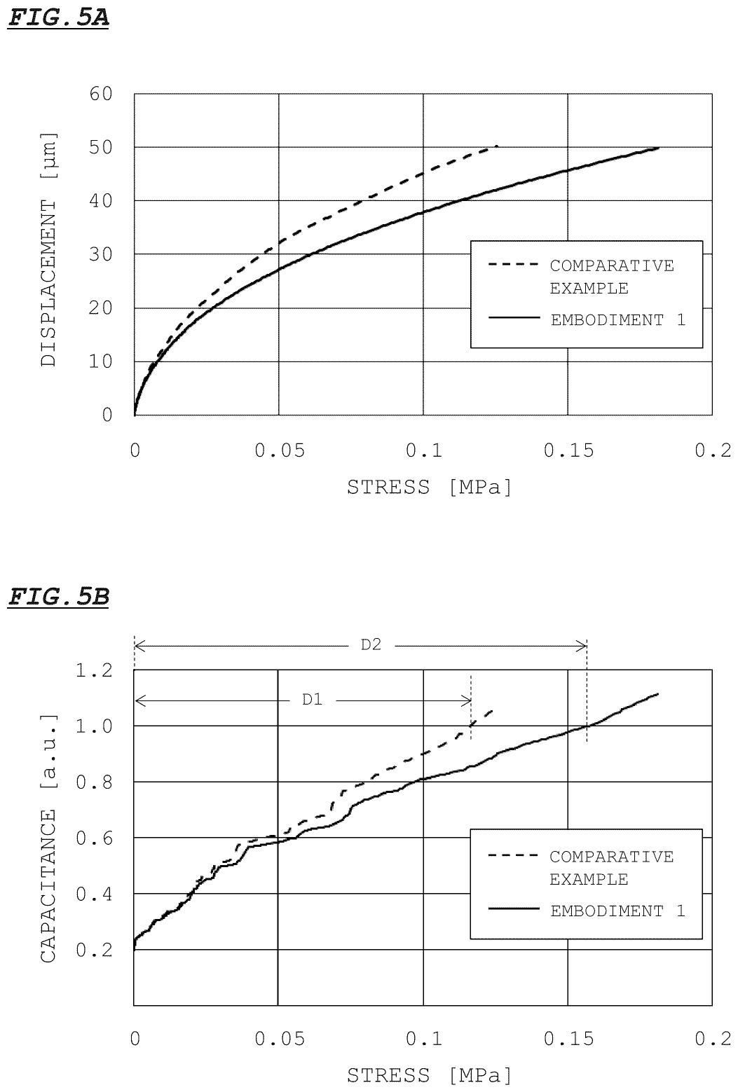

FIGS. 5A, 5B are each a graph showing a simulation result of Verification 1.

FIG. 5A is the simulation result of the relationship between the load and the displacement amount in the Z-axis negative direction of the vertex of the projection 301 in FIG. 4B, and FIG. 5B is the simulation result of the relationship between the load and the capacitance between the electrode 200 and the substrate 100. In FIGS. 5A, 5B, the simulation result of the comparative example is indicated by a broken line, and the simulation result of the embodiment is indicated by a solid line. The vertical axis of FIG. 5B is normalized.

As shown in FIG. 5A, in the configuration of Embodiment 1, as compared with the comparative example, displacement of the projection 301 with respect to the load was suppressed. Thus, it was possible to confirm that, when the projections 101 are provided on the upper face of the substrate 100 as in Embodiment 1, elastic deformation of the projection 301 of the electrically-conductive elastic body 300 with respect to the load is suppressed.

As shown in FIG. 5B, in the configuration of Embodiment 1, as compared with the comparative example, the range of the load until the same capacitance was attained was expanded. That is, in the comparative example, the range of the load until the capacitance reached the normalized value 1 was a range D1, whereas in Embodiment 1, a range D2 of the load until the capacitance reached the normalized value 1 was significantly expanded as compared with the range D1. Thus, it was possible to confirm that, when the projections 101 are provided on the upper face of the substrate 100 as in Embodiment 1, the dynamic range of load detection can be remarkably widened.

### <Verification 2>

Further, the inventors verified a case (reference example) where, instead of providing the projections 101 on the substrate 100, the surface roughness of the substrate 100 was made large. Here, the plane roughness was set to the upper limit value (Rz=0.02 mm) that can be assumed as the plane roughness of the substrate 100. Conditions other than omitting the projections 101 and setting the plane roughness were set to be the same as those of Verification 1 above.

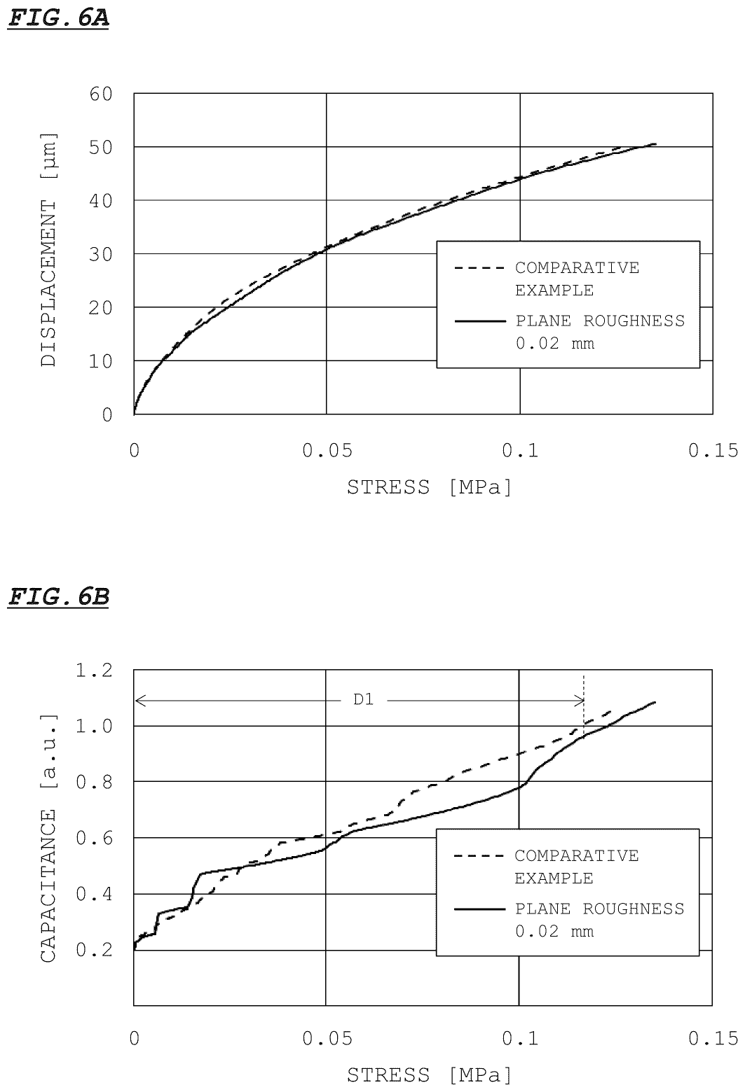

FIGS. 6A, 6B are each a graph showing a simulation result of Verification 2.

Similar to FIG. 5A, FIG. 6A is the simulation result of the relationship between the load and the displacement amount of the projection 301, and similar to FIG. 5B, FIG. 6B is the simulation result of the relationship between the load and the capacitance. In FIGS. 6A, 6B, the simulation result of the comparative example is indicated by a broken line, and the simulation result of the reference example is indicated by a solid line. The comparative example has the same configuration as that of Verification 1 above. Therefore, the simulation results of the comparative example are the same as those in FIGS. 5A, 5B. The vertical axis of FIG. 6B is normalized.

As shown in FIG. 6A, displacement of the projection 301 with respect to the load was substantially the same between the comparative example and the reference example. As shown in FIG. 6B, as for the relationship between the load and the capacitance as well, there was no large difference between the comparative example and reference example, and the range of the load until the capacitance reached the normalized value 1 was also substantially the same between the comparative example and the reference example. From these verifications, it was possible to confirm that, with merely the presence of fine unevenness unintentionally formed on the surface of the substrate 100, elastic deformation of the projection 301 of the electrically-conductive elastic body 300 cannot be suppressed, and the dynamic range of load detection cannot be expanded.

From this, in order to expand the dynamic range of load detection, it can be said that it is necessary to clearly form the projections 101 on the surface of the substrate 100 and cause the projections 101 to enter the inside of the electrically-conductive elastic body 300, as in the embodiment above.

### Effects of Embodiment 1

According to Embodiment 1, the following effects are exhibited.

As shown in FIGS. 3A, 3B, the projection 301 of the electrically-conductive elastic body 300 is compressed in the thickness direction due to load application. At this time, as for the electrically-conductive elastic body 300, movement in the horizontal direction is suppressed by the projection 101 (configuration that suppresses movement of the electrically-conductive elastic body 300 in the horizontal direction) of the substrate 100, and thus, the projection 301 of the electrically-conductive elastic body 300 is less likely to be elastically deformed. Accordingly, as shown in FIG. 5A, the projection 301 of the electrically-conductive elastic body 300 can be continued to be elastically deformed up to a high load range, and as a result, as shown in FIG. 5B, the range D2 of the detectable load can be remarkably widened. Therefore, the dynamic range of load detection can be widened by a simple configuration of suppressing movement of the electrically-conductive elastic body 300 in the horizontal direction.

As shown in FIG. 1 and FIGS. 2A, 2B, as the configuration that suppresses movement in the horizontal direction of the electrically-conductive elastic body 300, the load sensor 10 has the projection 101 formed on the surface (the joint region A1) of the substrate 100 to which the electrically-conductive elastic body 300 is joined, the projection having entered the inside of the electrically-conductive elastic body 300. Accordingly, movement in the horizontal direction of the electrically-conductive elastic body 300 can be effectively suppressed by a very simple configuration in which the projection 101 is formed on the surface (the joint region A1) of the substrate 100. Therefore, the projection 301 of the electrically-conductive elastic body 300 can be continued to be elastically deformed up to a high load range, and the dynamic range of load detection can be remarkably widened.

As shown in FIG. 1 and FIGS. 2A, 2B, a plurality of the projections 101 are formed on the surface (the joint region A1) of the substrate 100. Accordingly, movement in the horizontal direction of the electrically-conductive elastic body 300 can be effectively suppressed.

As shown in FIG. 1 and FIGS. 2A, 2B, it is preferable that the plurality of the projections 101 are evenly arranged in the joint region A1. Accordingly, movement in the horizontal direction of the electrically-conductive elastic body 300 can be uniformly suppressed. Therefore, each projection 301 of the electrically-conductive elastic body 300 can be continued to be evenly and elastically deformed up to a high load range.

As shown in FIG. 1 and FIGS. 2A, 2B, the projection 101 formed on the surface (the joint region A1) of the substrate 100 has a spherical surface shape. Accordingly, the projection 101 can be smoothly formed on the surface (the joint region A1) of the substrate 100.

When the height of the projection 101 is set to be half or more of the thickness T1 of the electrically-conductive elastic body 300, movement in the horizontal direction of the electrically-conductive elastic body 300 can be effectively suppressed, and the dynamic range of load detection can be remarkably widened, as shown in FIGS. 5A, 5B. However, the height of the projection 101 is not limited to half or more of the thickness T1 of the electrically-conductive elastic body 300, and may be set to a height, such as about ⅓ of the thickness T1 of the electrically-conductive elastic body 300, that can effectively suppress movement in the horizontal direction of the electrically-conductive elastic body 300.

As shown in FIG. 1, a plurality of the projections 301 are formed on the surface on the dielectric body 400 side of the electrically-conductive elastic body 300. Accordingly, change in the contact area between the dielectric body 400 and the projections 301 during load application can be made large. Therefore, sensitivity of load detection can be enhanced.

As described with reference to FIG. 1, the substrate 100 is formed from an electrically-conductive material. Therefore, the substrate 100 can also be used as one electrode for detecting change in the capacitance, and it is not necessary to separately draw a wiring cable from the electrically-conductive elastic body 300. Therefore, the configuration of the load sensor 10 can be simplified.

### Embodiment 2

In Embodiment 1 above, as the configuration that suppresses movement in the horizontal direction of the electrically-conductive elastic body 300, the projections 101 are formed on the substrate 100. That is, the projections 101 are the structure that suppresses movement in the horizontal direction of the electrically-conductive elastic body 300. In contrast, in Embodiment 2, as the configuration that suppresses movement in the horizontal direction of the electrically-conductive elastic body 300, a wall surface close to the edge of the electrically-conductive elastic body 300 in the horizontal direction is formed at the substrate 100. That is, in Embodiment 2, this wall surface serves as the structure that suppresses movement in the horizontal direction of the electrically-conductive elastic body 300.

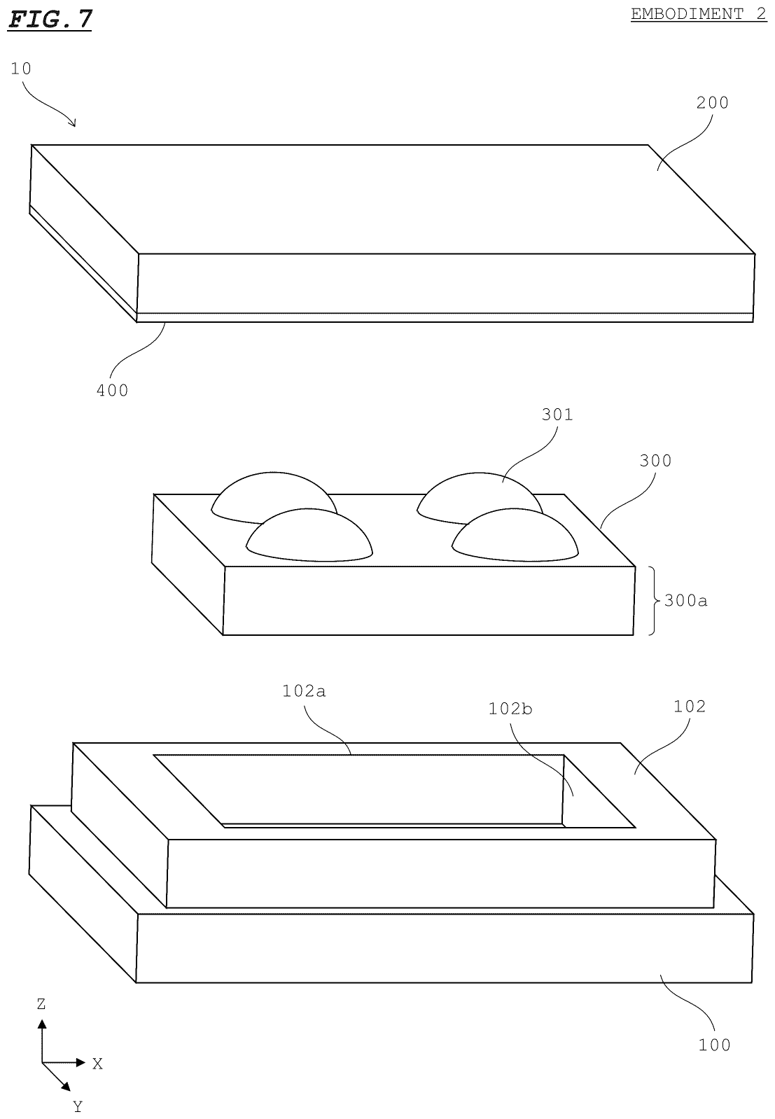

FIG. 7 is an exploded perspective view schematically showing a configuration of the load sensor 10 according to Embodiment 2.

In FIG. 7, the configurations of the electrode 200, the electrically-conductive elastic body 300, and the dielectric body 400 are the same as the configurations in Embodiment 1 shown in FIG. 1. In Embodiment 2, instead of the projections 101 shown in FIG. 1, a wall part 102 is formed on the upper face of the substrate 100. The width in the X-axis direction of the wall part 102 and the width in the Y-axis direction of the wall part 102 are the same with each other. In a plan view, the contour of the wall part 102 is substantially square.

A recess 102a is formed on the inner side of the wall part 102, and the inner surface of this recess 102a serves as wall surfaces 102b. The shape of the recess 102a in a plan view is substantially square. A pair of the wall surfaces 102b opposed to each other in the X-axis direction are flat surfaces parallel to a Y-Z plane, and a pair of the wall surfaces 102b opposed to each other in the Y-axis direction are flat surfaces parallel to an X-Z plane. The height of the wall part 102 is constant over the entire periphery. Here, the height of the wall part 102 is substantially identical to the thickness of the thickness portion 300a, other than the projections 301, of the electrically-conductive elastic body 300. The bottom face of the recess 102a is the upper face of the portion of the substrate 100 other than the wall part 102. The region of this bottom face serves as the joint region A1 shown in FIG. 1. In Embodiment 2, the bottom face of the recess 102a is a flat surface and no projection 101 is formed on this bottom face.

The wall part 102 is formed integrally with the substrate 100 by press working, for example. The wall part 102 may be formed integrally with the upper face of the substrate 100 by outsert molding or the like. In this case, the wall part 102 may be formed from a material, such as a resin, different from that of the substrate 100.

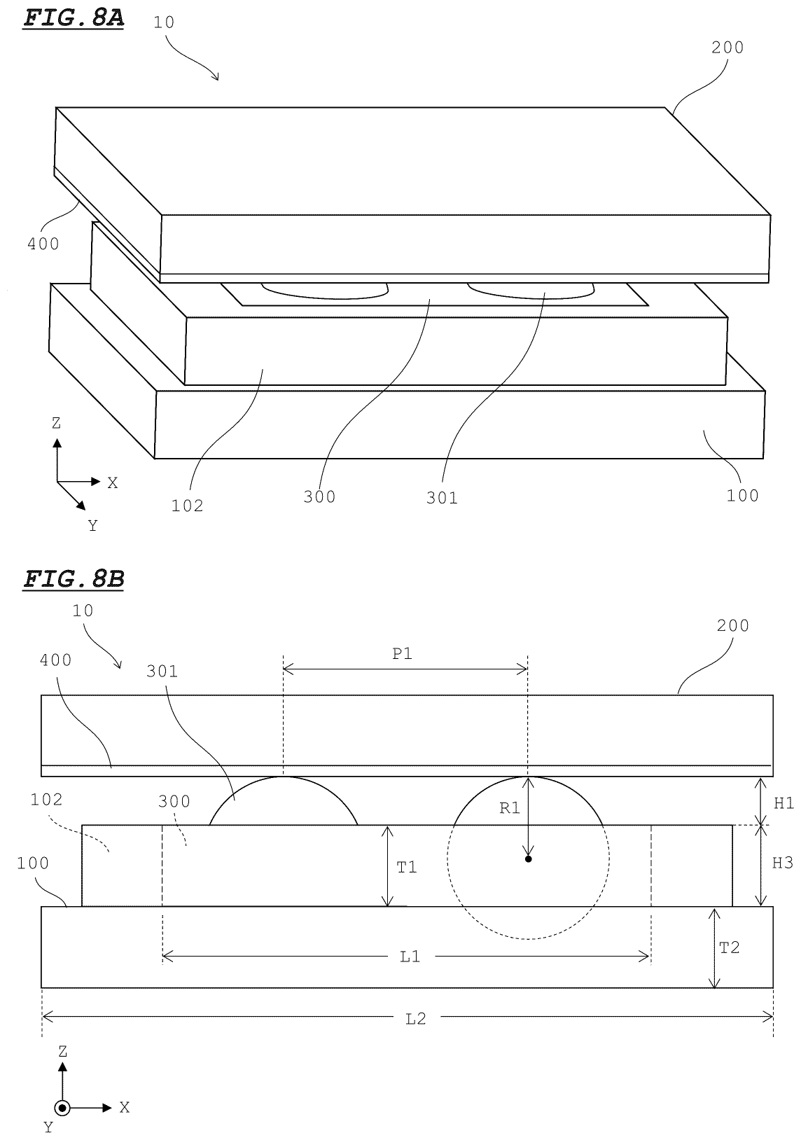

During assembly of the load sensor 10, the electrically-conductive elastic body 300 is formed integrally with the recess 102a of the substrate 100 by outsert molding or the like. At the same time, a plurality of the projections 301 are formed on the upper face of the electrically-conductive elastic body 300. Further, a structure composed of the dielectric body 400 and the electrode 200 is superposed on the upper face of the electrically-conductive elastic body 300 such that the dielectric body 400 is opposed to the electrically-conductive elastic body 300. Accordingly, the structure shown in FIG. 8A is formed. Protection substrates (not shown) formed from a resin material are superposed on the upper face and the lower face of this structure, respectively, and the peripheries of these protection substrates are joined by a setting member. Then, the load sensor 10 is completed.

In Embodiment 2, spreading in the horizontal direction of the thickness portion 300a of the electrically-conductive elastic body 300 is suppressed by the wall surface 102b. Therefore, spreading in the horizontal direction of the electrically-conductive elastic body 300 during load application is suppressed, and movement of a part of the volume of the projections 301 to the thickness portion 300a of the electrically-conductive elastic body 300 during load application is suppressed. Accordingly, during load application, the projections 301 are less likely to be elastically deformed downwardly and changes in the contact area S1 and the gap G1 (see FIGS. 3A, 3B) during load application become gentle. As a result, the dynamic range of load detection can be expanded as compared with a case where there is no projection 101.

### <Verification 3>

The inventors verified, through simulation, effects according to the configuration of Embodiment 2, i.e., effects of providing the wall surface 102b.

FIG. 8B is a diagram for describing a simulation condition of the present verification.

In the present verification, as in Verification 1 above, it is assumed that four projections 301 are formed on the upper face of the electrically-conductive elastic body 300. The condition (the pitch P1, the radius R1, the thickness T1, the height H1, the length L1) set for the electrically-conductive elastic body 300 is the same as that in Verification 1 above, and the condition (the thickness T2, the length L2) set for the substrate 100 is the same as that in Verification 1 above. In the present verification, a height H3 of the wall part 102 is set to 0.1 mm. That is, the height H3 of the wall part 102 is set to be the same as the thickness T1 of the electrically-conductive elastic body 300.

Under this condition, as in Verification 1 above, the relationship between the load and the displacement amount in the Z-axis negative direction of the vertex of the projection 301 and the relationship between the load and the capacitance between the electrode 200 and the substrate 100 were each obtained through simulation.

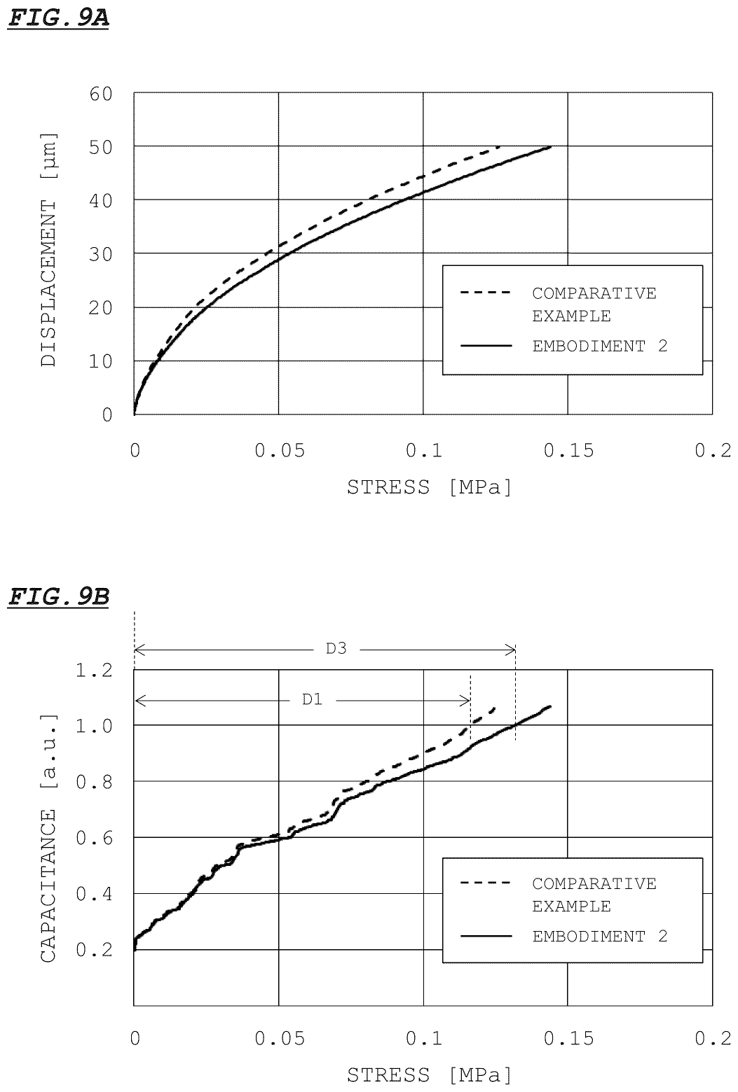

FIGS. 9A, 9B are each a graph showing a simulation result of Verification 3.

FIG. 9A is the simulation result of the relationship between the load and the displacement amount in the Z-axis negative direction of the vertex of the projection 301, and FIG. 9B is the simulation result of the relationship between the load and the capacitance between the electrode 200 and the substrate 100. In FIGS. 9A, 9B, the simulation result of the comparative example is indicated by a broken line and the simulation result of Embodiment 2 is indicated by a solid line. The vertical axis of FIG. 9B is normalized. The configuration of the comparative example is the same as that in Verification 1 above.

As shown in FIG. 9A, in the configuration of Embodiment 2 as well, as compared with the comparative example, displacement of the projection 301 with respect to the load was suppressed. Thus, it was possible to confirm that, when the wall surface 102b close to the outer surface of the electrically-conductive elastic body 300 is provided at the upper face of the substrate 100 as in Embodiment 2, elastic deformation of the projection 301 of the electrically-conductive elastic body 300 with respect to the load is suppressed.

As shown in FIG. 9B, in the configuration of Embodiment 2 as well, as compared with the comparative example, the range of the load until the same capacitance was attained was expanded. That is, in the comparative example, the range of the load until the capacitance reached the normalized value 1 was the range D1, whereas in Embodiment 2, a range D3 of the load until the capacitance reached the normalized value 1 was expanded as compared with the range D1. Thus, it was possible to confirm that, when the wall surface 102b is provided at the upper face of the substrate 100 as in Embodiment 2, the dynamic range of load detection can be widened.

### <Verification 4>

In Verification 4, in the configuration of Embodiment 2 in Verification 3 above, further, four projections 101 are formed on the bottom face of the recess 102a. As in Verification 1 above, the four projections 101 are disposed at positions directly below the projections 301 of the electrically-conductive elastic body 300. The simulation condition (the pitch P2, the radius R2, the height H2) for the projections 101 is the same as that in Verification 1 above. In the following, the configuration according to Verification 4 will be referred to as “Embodiment 1/2”.

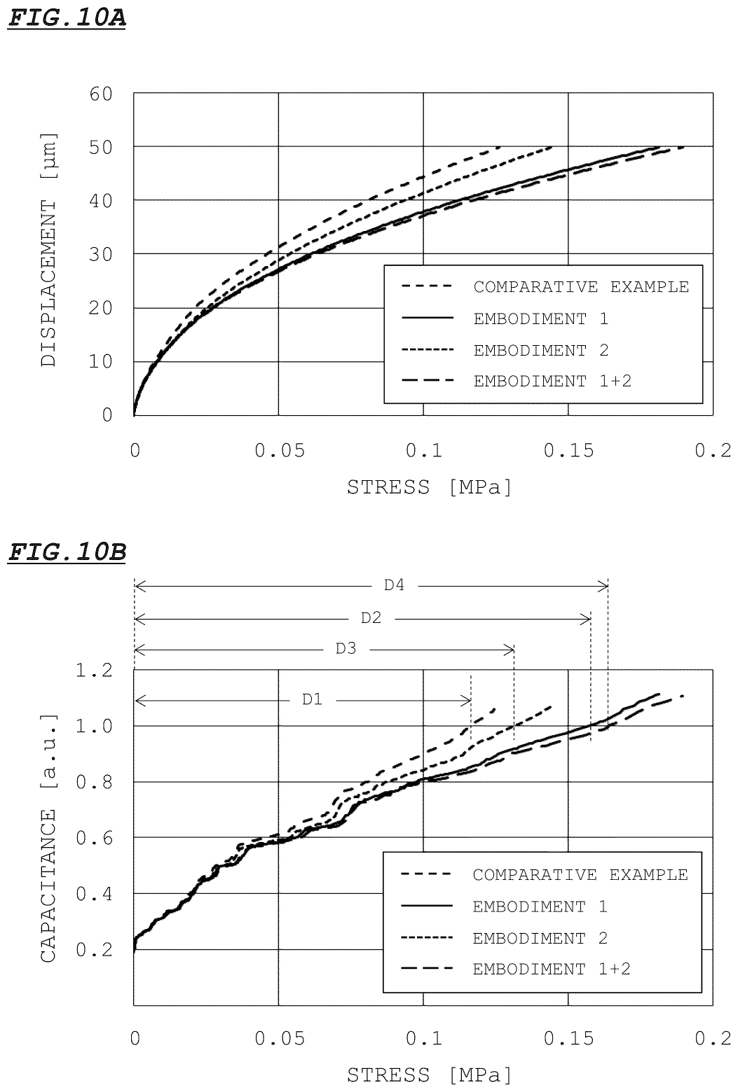

FIGS. 10A, 10B are each a graph showing a simulation result of Verification 4.

FIG. 10A is the simulation result of the relationship between the load and the displacement amount in the Z-axis negative direction of the vertex of the projection 301, and FIG. 10B is the simulation result of the relationship between the load and the capacitance between the electrode 200 and the substrate 100. In FIGS. 10A, 10B, the simulation result of the comparative example is indicated by a broken line, and the simulation result of Embodiment 1/2 is indicated by a long broken line. The configuration of the comparative example is the same as that in Verification 1 above. Further, in FIGS. 10A, 10B, the simulation results of Embodiment 1 and Embodiment 2 are indicated by a solid line and a dotted line, respectively. The vertical axis of FIG. 10B is normalized.

As shown in FIG. 10A, in the configuration of Embodiment 1/2, as compared with the configuration of Embodiment 1, displacement of the projection 301 with respect to the load was slightly suppressed. Thus, it was possible to confirm that, when both of the projections 101 and the wall surface 102b close to the outer surface of the electrically-conductive elastic body 300 are provided at the upper face of the substrate 100 as in Embodiment 1/2, elastic deformation of the projection 301 of the electrically-conductive elastic body 300 with respect to the load is remarkably suppressed.

As shown in FIG. 10B, in the configuration of Embodiment 1/2, as compared with the range D2 in Embodiment 1, a range D4 of the load until the same capacitance was attained was slightly expanded. Thus, it was possible to confirm that, when both of the projections 101 and the wall surface 102b are provided at the upper face of the substrate 100 as in Embodiment 1/2, the dynamic range of load detection can be remarkably widened.

As shown in FIG. 10A, with respect to the same load, the difference between the displacement amount in Embodiment 2 and the displacement amount in Embodiment 1/2 is large, but the difference between the displacement amount in Embodiment 1 and the displacement amount in Embodiment 1/2 is small. As shown in FIG. 10B, the difference between the range D3 in Embodiment 2 and the range D4 in Embodiment 1/2 is large, but the difference between the range D2 in Embodiment 1 and the range D4 in Embodiment 1/2 is small. From this, in order to expand the dynamic range of load detection by effectively suppressing the displacement amount of the projection 301 with respect to the load, it can be said that forming the projection 101, rather than the wall surface 102b, on the substrate 100 is more effective.

### Embodiment 3

In Embodiment 1 above, as the configuration that suppresses movement in the horizontal direction of the electrically-conductive elastic body 300, the projections 101 are formed on the substrate 100. In contrast, in Embodiment 3, as the configuration that suppresses movement in the horizontal direction of the electrically-conductive elastic body 300, the thickness of the portion, other than the projections 301, of the electrically-conductive elastic body 300 is adjusted.

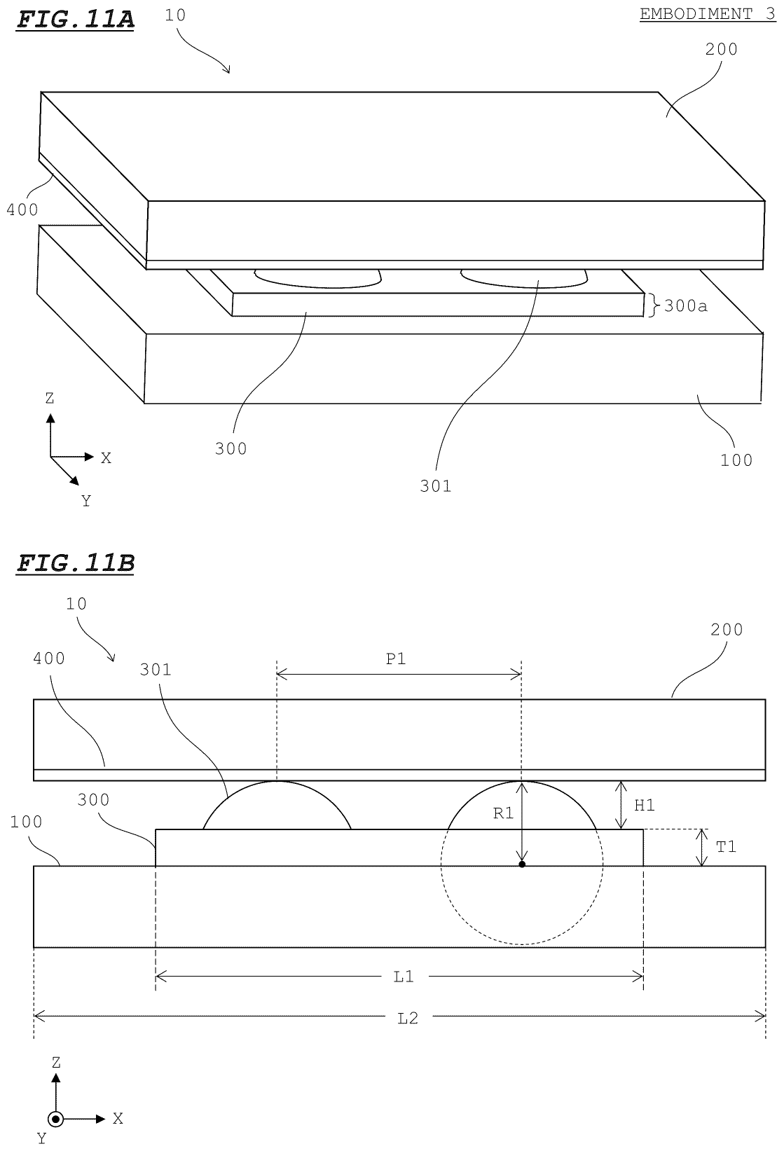

FIG. 11A is a perspective view schematically showing a configuration of the load sensor 10 according to Embodiment 3.

In Embodiment 3, neither the projection 101 nor the wall part 102 is formed on the upper face of the substrate 100, and the upper face of the substrate 100 is a uniform flat surface. In Embodiment 3, the thickness of the portion, other than the projections 301, of the electrically-conductive elastic body 300 is set to be in a predetermined range. The other configurations of Embodiment 3 are the same as those in Embodiment 1 above.

In a case where the thickness of the portion, other than the projections 301, of the electrically-conductive elastic body 300 is smaller, when the projections 301 are elastically deformed in the Z-axis direction due to load application, the volume portion of the projections 301 is less likely to move to the thickness portion 300a immediately therebelow and the thickness portion 300a is less likely to move in the horizontal direction. Therefore, when the thickness of the thickness portion 300a becomes smaller, the projections 301 are less likely to be elastically deformed during load application, and changes in the contact area S1 and the gap G1 (see FIGS. 3A, 3B) associated with increase in the load become gentle. Accordingly, the dynamic range of load detection can be expanded.

On the other hand, when this thickness becomes smaller, it becomes difficult to produce the electrically-conductive elastic body 300. That is, when the thickness is excessively small, the strength of the electrically-conductive elastic body 300 cannot be maintained, during formation of the electrically-conductive elastic body 300, to an extent that the mold can be removed from the electrically-conductive elastic body 300. Therefore, it is preferable that the thickness of the thickness portion 300a, other than the projections 301, of the electrically-conductive elastic body 300 is not excessively small.

### <Verification 5>

The inventors obtained, through simulation, the lower limit value of the thickness of the thickness portion 300a, other than the projections 301, of the electrically-conductive elastic body 300.

FIG. 11B is a diagram for describing a simulation condition of the present verification.

In the present verification, as in Verification 1 above, it is assumed that four projections 301 are formed on the upper face of the electrically-conductive elastic body 300. The condition (the pitch P1, the radius R1, the height H1, the length L1) set for the electrically-conductive elastic body 300 is the same as that in Verification 1 above, and the condition (the thickness T2, the length L2) set for the substrate 100 is the same as that in Verification 1 above. In the present verification, the thickness T1 of the electrically-conductive elastic body 300 was set to four types, i.e., 0.1 mm, 0.095 mm, 0.01 mm, and 0.005 mm.

Under this condition, as in Verification 1 above, the relationship between the load and the displacement amount in the Z-axis negative direction of the vertex of the projection 301 and the relationship between the load and the capacitance between the electrode 200 and the substrate 100 were each obtained through simulation.

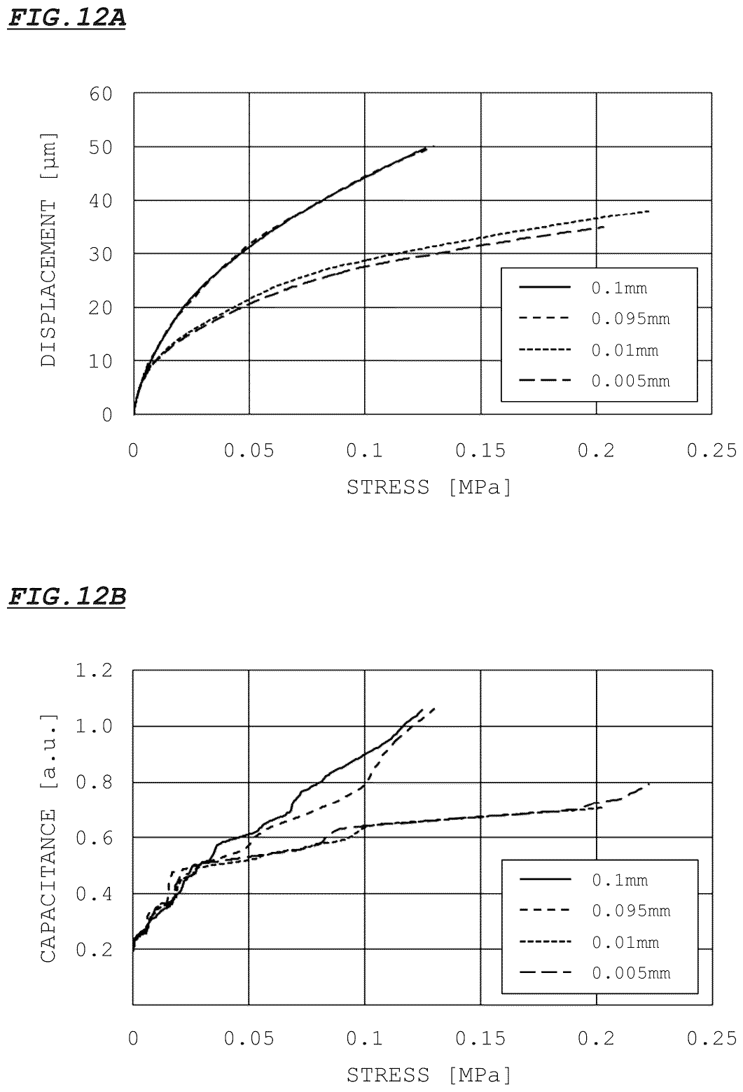

FIGS. 12A, 12B are each a graph showing a simulation result of Verification 5.

FIG. 12A is the simulation result of the relationship between the load and the displacement amount in the Z-axis negative direction of the vertex of the projection 301, and FIG. 12B is the simulation result of the relationship between the load and the capacitance between the electrode 200 and the substrate 100. The vertical axis of FIG. 12B is normalized.

As shown in FIGS. 12A, 12B, when the thickness T1 of the electrically-conductive elastic body 300 became smaller, the projection 301 was less likely to be compressed in the Z-axis direction during load application, and the dynamic range of load detection was expanded. However, between the case where the thickness T1 was 0.01 mm and the case where the thickness T1 was 0.005 mm, the levels of the projection 301 not being compressed during load application were substantially the same, and the widths of the dynamic range of load detection were substantially at the same level. Therefore, the lower limit value of the thickness T1 may be set to about 0.01 mm.

When the thickness T1 is 0.01 mm, the ratio (V2/V1) of a volume V2 of the thickness portion 300a immediately below the projections 301 relative to a volume V1 of the projections 301 is 98%. The volume V1 is the sum of the volumes of the four projections 301 in the configuration in FIG. 11B, and the volume V2 is the volume of the thickness portion 300a of the electrically-conductive elastic body 300 other than the projections 301. Therefore, from the verification results in FIGS. 12A, 12B, it can be said that it is preferable that the ratio (V2/V1) is 98% or higher.

### <Verification 6>

When the thickness of the thickness portion 300a of the electrically-conductive elastic body 300 is larger, the use amount of the material increases, and the material cost increases. In addition, when the thickness of the thickness portion 300a is excessively large, the mold machining cost also increases. Therefore, it is preferable that the thickness of the thickness portion 300a, other than the projections 301, of the electrically-conductive elastic body 300 is not excessively large.

Therefore, the inventors verified the upper limit value of the thickness T1 through simulation.

Here, the thickness T1 was set to four types, i.e., 0.1 mm, 0.2 mm, 1.0 mm, and 2.0 mm. The other conditions were set to be the same as those in Verification 5 above.

Under this condition, as in Verification 1 above, the relationship between the load and the displacement amount in the Z-axis negative direction of the vertex of the projection 301 and the relationship between the load and the capacitance between the electrode 200 and the substrate 100 were each obtained through simulation.

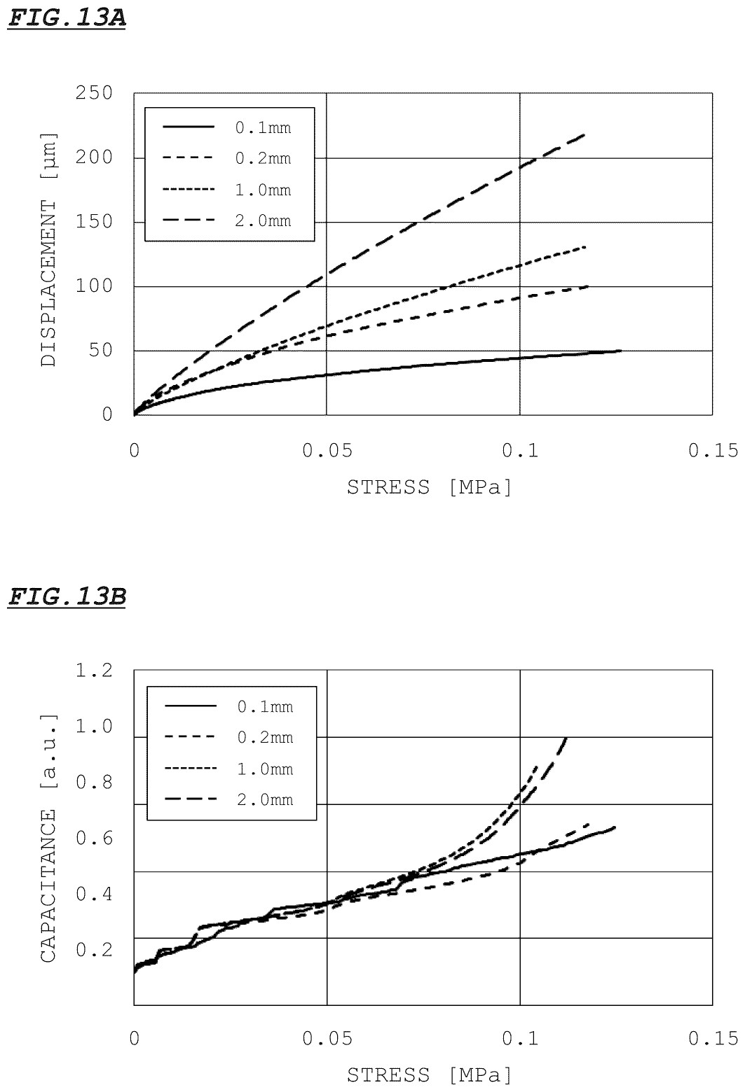

FIGS. 13A, 13B are each a graph showing a simulation result of Verification 6.

FIG. 13A is the simulation result of the relationship between the load and the displacement amount in the Z-axis negative direction of the vertex of the projection 301, and FIG. 13B is the simulation result of the relationship between the load and the capacitance between the electrode 200 and the substrate 100. The vertical axis of FIG. 13B is normalized.

As shown in FIGS. 13A, 13B, when the thickness T1 of the electrically-conductive elastic body 300 became large, the projection 301 was more likely to be displaced in the Z-axis direction during load application, and the dynamic range of load detection was reduced. Here, between the case where the thickness T1 was 1.0 mm and the case where the thickness T1 was 2.0 mm, the widths of the dynamic range of load detection were substantially at the same level. Therefore, the upper limit value of the thickness T1 may be set to about 1.0 mm. Accordingly, the electrically-conductive elastic body 300 can be prevented from becoming thick more than necessary, and increase in the material cost and the production cost can be avoided.

When the thickness T1 is 1.0 mm, the ratio (V2/V1) of the volume V2 of the thickness portion 300a immediately below the projections 301 relative to the volume V1 of the projections 301 is 9800%. Therefore, from the verification results in FIGS. 13A, 13B, it can be said that it is preferable that the ratio (V2/V1) is 9800% or lower.

However, in order to expand the dynamic range of load detection, it is preferable that the thickness T1 is as small as possible in the range down to the lower limit value shown in Verification 5 above.

### <Modification>

The configuration of the load sensor 10 can be modified in various ways other than the configurations shown in Embodiments 1 to 3 above.

For example, in Embodiment 1 above, the projection 101 formed on the upper face of the substrate 100 has a spherical surface shape. However, the shape of the projection 101 is not limited thereto.

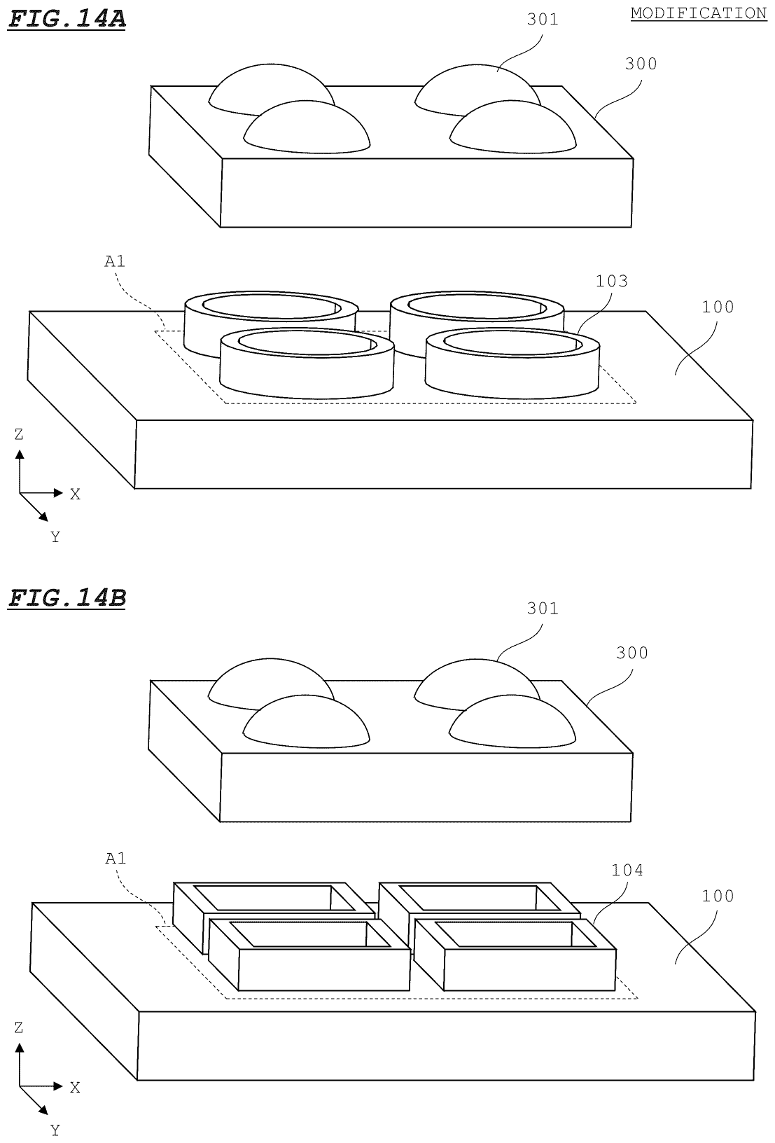

For example, as shown in FIG. 14A, projections 103 each having a circular cylindrical shape may be formed in the joint region A1 of the upper face of the substrate 100, or, as shown in FIG. 14B, projections 104 each having a polygonal cylindrical shape may be formed in the joint region A1.

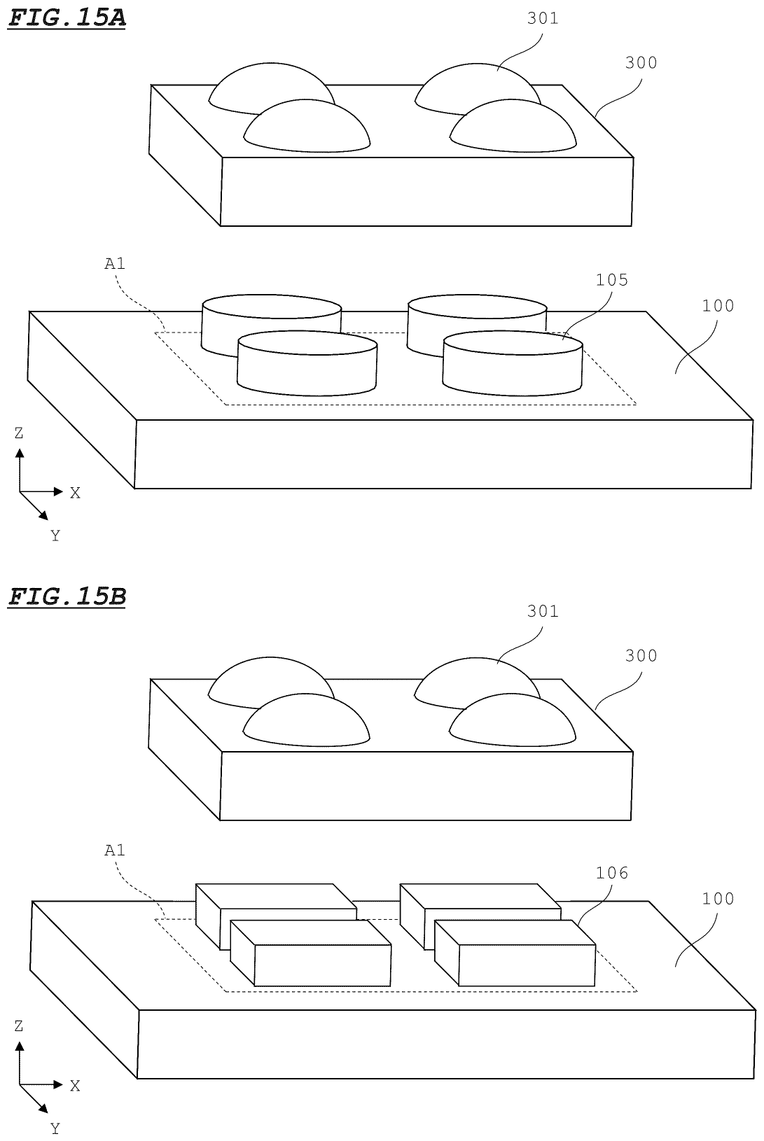

As shown in FIG. 15A, projections 105 each having a circular columnar shape may be formed in the joint region A1 of the upper face of the substrate 100, or as shown in FIG. 15B, projections 106 each having a polygonal columnar shape may be formed in the joint region A1.

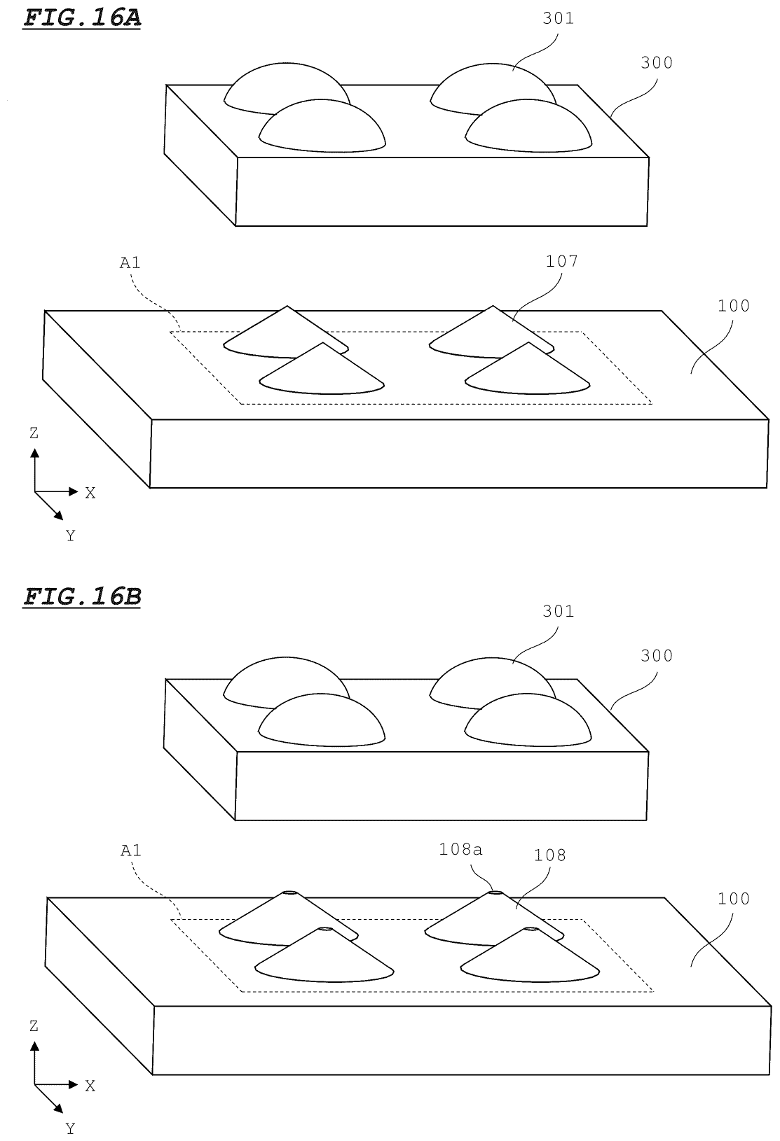

As shown in FIG. 16A, projections 107 each having a cone shape may be formed in the joint region A1 of the upper face of the substrate 100, or, as shown in FIG. 16B, the top portion of projections 108 each having a cone shape may be cut off in parallel to an X-Y plane into a plane 108a. Projections each having a pyramid shape may be formed in the joint region A1, and the top portion of the pyramid may be a plane.

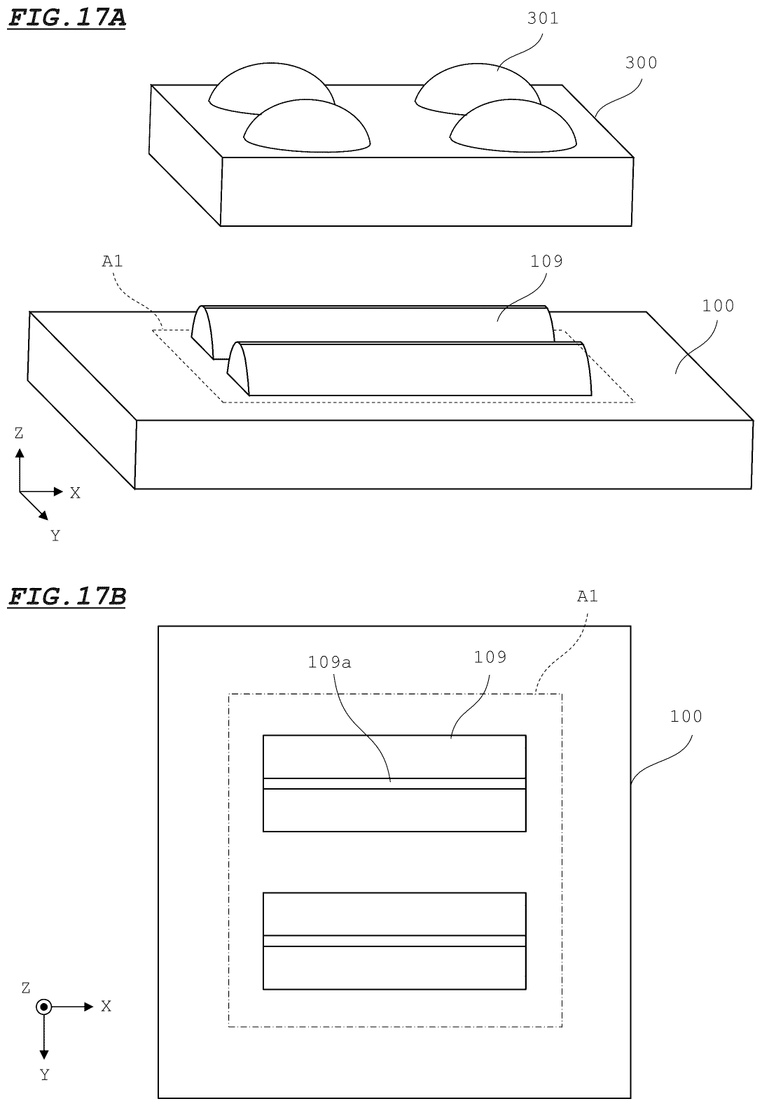

As shown in FIGS. 17A, 17B, projections 109 each having a ridge shape extending in the X-axis direction may be formed in the joint region A1 of the upper face of the substrate 100. In this configuration example, the projection 109 has a semicircular columnar shape of which the generatrix is parallel to the X-axis, and its top portion is cut off in parallel to an X-Y plane into a plane 109a. The top portion of the projection 109 need not necessarily be cut off in parallel to an X-Y plane.

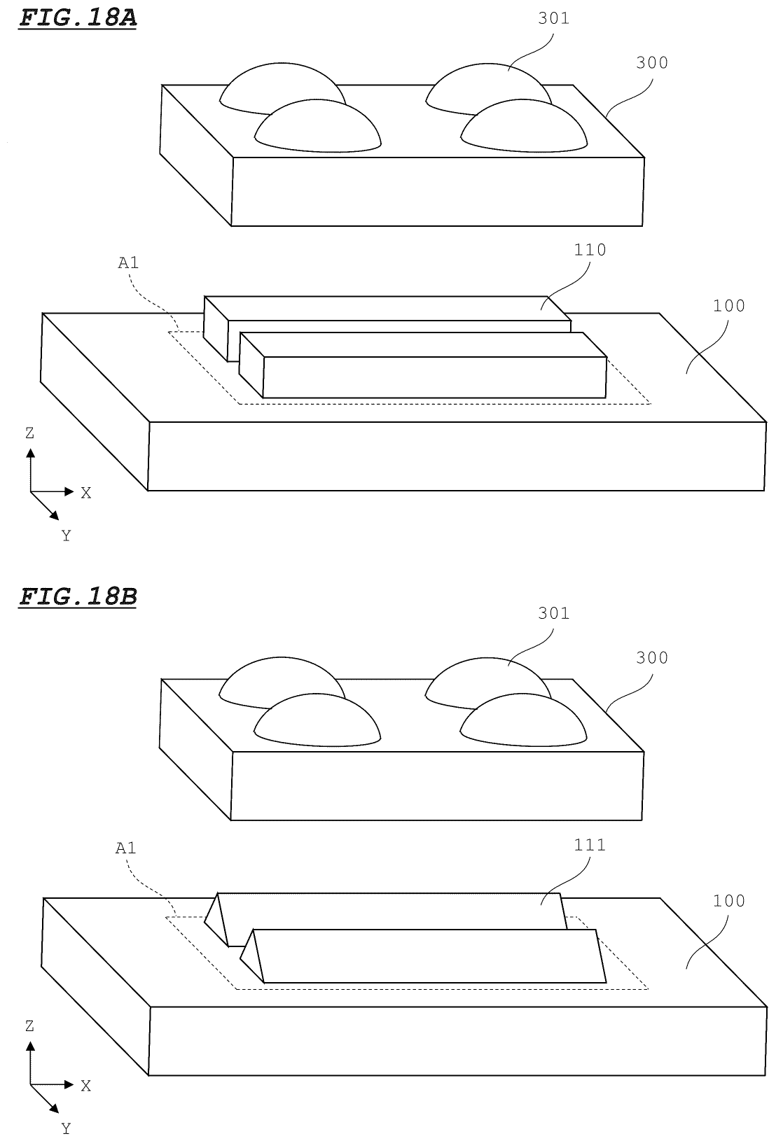

As shown in FIG. 18A, projections 110 formed in the joint region A1 may each have a ridge shape of which a cross section is rectangular, or as shown in FIG. 18B, projections 111 each having a ridge shape of which a cross section is triangular may be formed in the joint region A1. The cross section of the ridge shape is not limited to these, and may be trapezoidal, for example. In the configuration in FIG. 18B, as in FIG. 17A, the top portion of the projection 111 may be cut off into a planar shape.

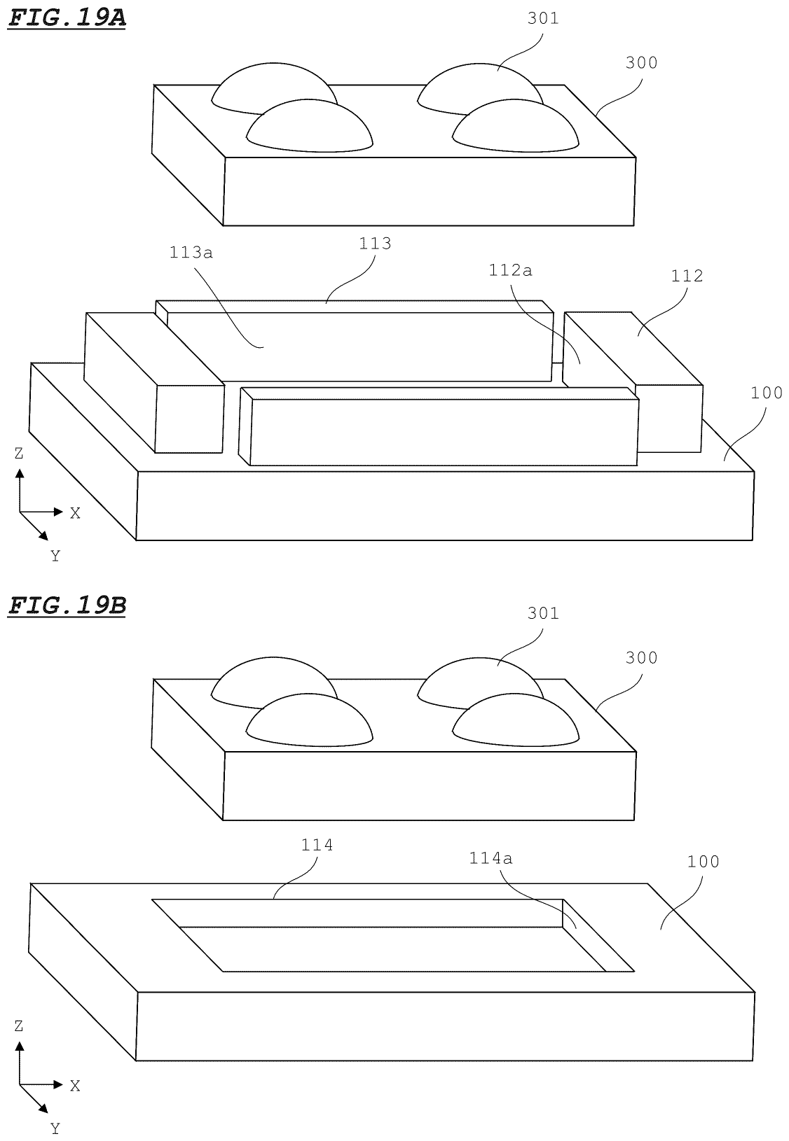

In Embodiment 2 above, as shown in FIG. 7, the wall surface 102b is disposed so as to surround the entire periphery of the electrically-conductive elastic body 300, but the disposition of the wall surface 102b is not limited thereto. For example, as shown in FIG. 19A, a pair of wall parts 112 opposed to each other in the X-axis direction and a pair of wall parts 113 opposed to each other in the Y-axis direction may be formed on the upper face of the substrate 100, and wall surfaces 112a, 113a which are the inner surfaces of these wall parts 112, 113 may be close to the side face of the electrically-conductive elastic body 300.

In this case, either one of the pair of wall parts 112 and the pair of wall parts 113 may be omitted. However, in this case, the electrically-conductive elastic body 300 becomes movable in the direction of the side face corresponding to the omitted wall parts, and thus, the projections 301 are considered to correspondingly become more likely to be displaced in the Z-axis direction during load application, resulting in a narrower dynamic range of load detection. Therefore, in order to more effectively expand the dynamic range of load detection, it is preferable that two pairs of the wall parts 112, 113 are disposed as shown in FIG. 19A, and it is preferable that the wall part 102 is continuously formed over the entire periphery of the electrically-conductive elastic body 300 as in Embodiment 2 above.

The wall surface that restricts movement in the horizontal direction of the electrically-conductive elastic body 300 need not necessarily be formed by a wall part. For example, as shown in FIG. 19B, a recess 114 may be formed in the region corresponding to the joint region A1 of the upper face of the substrate 100, whereby a wall surface 114a close to the side face of the electrically-conductive elastic body 300 may be formed.

The close state of the wall surface with respect to the edge of the electrically-conductive elastic body 300 in the horizontal direction need not necessarily be in a state of being in contact with the side face of the electrically-conductive elastic body 300 as in Embodiment 2 above, and may be opposed to the side face of the electrically-conductive elastic body 300 with a minute gap therebetween.

In Embodiment 2 shown in FIG. 7, the height of the wall surface 102b and the thickness of the electrically-conductive elastic body 300 are substantially the same. However, these may be different from each other. For example, the height of the wall surface 102b may be smaller than the thickness of the electrically-conductive elastic body 300. However, in this case, as for the portion of the electrically-conductive elastic body 300 exceeding the height of the wall surface, movement in the horizontal direction is not restricted, and thus, the projections 301 are assumed to correspondingly become more likely to be displaced in the Z-axis direction during load application, resulting in a narrower dynamic range of load detection. When the height of the wall surface 102b is larger than the thickness of the electrically-conductive elastic body 300, it may happen that the upper face of the wall part 102 comes into contact with the dielectric body 400 before the projections 301 are completely squashed during load application. Therefore, in order to more effectively expand the dynamic range of load detection, the height of the wall surface is preferably as large as possible within a range of not exceeding the thickness of the electrically-conductive elastic body 300, and is most preferably substantially identical to the thickness of the electrically-conductive elastic body 300.

In the embodiments above, the shape of the electrically-conductive elastic body 300 in a plan view is a square. However, the shape of the electrically-conductive elastic body 300 in a plan view may be another shape such as a rectangle or a circle. In this case, in accordance with change in the shape of the electrically-conductive elastic body 300 in a plan view, the shape of the joint region A1 shown in FIG. 1 also changes and the shape in a plan view of the wall surface 102b shown in FIG. 7 is also changed.

The shape, the size, and the number of the projections 301 formed on the upper face of the electrically-conductive elastic body 300 are not necessarily limited to those shown in Embodiments 1 to 3 above.

For example, the shape of the projection 301 may be a shape obtained by cutting off a top portion of a hemispherical surface by a plane parallel to an X-Y plane. Alternatively, the shape of the projection 301 may be a cone or a pyramid, or may be a shape obtained by cutting off a top portion of a cone or a pyramid by a plane parallel to an X-Y plane. The projection 301 is preferably a shape of which the cross-sectional area is reduced toward the leading end thereof.

Alternatively, the projection 301 may be a ridge that is long in the X-axis direction. For example, the projection 301 may be a ridge having a semicircular columnar shape.

The shapes and the heights may be different between the projections 301, and the pitch of the projections 301 need not necessarily be constant. For example, the height and the pitch of the projections 301 may be adjusted such that the dynamic range of load detection expands. Alternatively, from the viewpoint of making change in the capacitance with respect to the load more close to being linear, the height and the pitch of the projections 301 may be adjusted.

Only one large projection 301 may be disposed on the upper face of the electrically-conductive elastic body 300, or five or more projections 301 may be disposed thereon.

Similarly, in the configuration of Embodiment 1 above, the shape, the size, the height, the number, and the pitch of the projections 101 formed on the upper face of the substrate 100 are not necessarily limited to those shown in Embodiment 1 and the modifications in FIG. 14A to FIG. 18B above. As long as movement in the horizontal direction of the electrically-conductive elastic body 300 can be restricted and the dynamic range of load detection can be widened, the shape, the size, the height, the number, and the pitch of the projections 101 formed on the upper face of the substrate 100 can be changed as appropriate. For example, only one projection 101 may be disposed on the upper face of the substrate 100, or the projections 101 in a number other than those shown above may be disposed thereon.

When a plurality of the projections 101 are formed on the upper face of the substrate 100, the shape, the size, the height, and the pitch of these projections 101 need not necessarily be the same with each other. For example, these parameters regarding the projection 101 may be adjusted such that displacement in the Z-axis direction of the projection 301 during load application can be more appropriately adjusted.

In addition, the configuration of the load sensor 10 may be a configuration other than the configurations shown above. For example, in Embodiment 1 above, as shown in FIG. 1, for one electrode 200 having the dielectric body 400 formed on the lower face thereof, only one set of the electrically-conductive elastic body 300 and the substrate 100 is disposed. However, for one electrode 200, a plurality of sets of the electrically-conductive elastic body 300 and the substrate 100 may be disposed.

In the configuration in FIG. 1, the electrode 200 may be divided into two in the X-axis direction, and the dielectric body 400 may be formed on the lower face of each of the divided two electrodes 200. In this case, the set of the electrode 200 and the dielectric body 400 on the X-axis positive side is superposed on the two projections 301 on the X-axis positive side, and the set of the electrode 200 and the dielectric body 400 on the X-axis negative side is superposed on the two projections 301 on the X-axis negative side.

In addition to the above, various modifications can be made as appropriate to the embodiments of the present invention, without departing from the scope of the technological idea defined by the claims.

What is claimed is:

1. A load sensor comprising:
an electrode;
a dielectric body disposed on a surface of the electrode;
an electrically-conductive elastic body that is disposed so as to be opposed to the dielectric body and of which a surface on the dielectric body side has a projection formed thereon;
a substrate configured to support the electrically-conductive elastic body; and
a configuration that suppresses movement of the electrically-conductive elastic body in a horizontal direction.

2. The load sensor according to claim 1, wherein
the configuration that suppresses movement of the electrically-conductive elastic body includes a projection formed on a surface of the substrate to which the electrically-conductive elastic body is joined, the projection having entered an inside of the electrically-conductive elastic body.

3. The load sensor according to claim 2, wherein
a plurality of the projections are formed on the surface of the substrate.

4. The load sensor according to claim 2, wherein
the projection formed on the surface has a spherical surface shape, a cone or pyramid shape, a columnar shape, a cylindrical shape, or a ridge shape.

5. The load sensor according to claim 1, wherein
the configuration that suppresses movement of the electrically-conductive elastic body includes a wall surface formed at the substrate and close to an edge of the electrically-conductive elastic body in the horizontal direction.

6. The load sensor according to claim 5, wherein
the wall surface is formed over an entire periphery of the electrically-conductive elastic body.

7. The load sensor according to claim 5, wherein
a height of the wall surface is substantially identical to a thickness of the electrically-conductive elastic body.

8. The load sensor according to claim 1, wherein
the configuration that suppresses movement of the electrically-conductive elastic body corresponds to setting a ratio of a volume of the electrically-conductive elastic body in a portion immediately below the projection of the electrically-conductive elastic body, relative to a volume of the projection, to 98% or higher and 9800% or lower.

9. The load sensor according to claim 1, wherein
a plurality of the projections are formed on the surface on the dielectric body side of the electrically-conductive elastic body.

10. The load sensor according to claim 1, wherein
the substrate is formed from an electrically-conductive material.
